(19) United States
(12) Patent Application Publication
(10) Pub. No.: US 2024/0003244 A1
(43) Pub. Date: Jan. 4, 2024

(54) WELLHEAD LEAK DETECTION AND REMEDIATION CAPPING SYSTEM

(71) Applicant: Talal Atif Debs, Fort Lauderdale, FL (US)

(72) Inventor: Talal Atif Debs, Fort Lauderdale, FL (US)

(21) Appl. No.: 18/216,567

(22) Filed: Jun. 29, 2023

Related U.S. Application Data
(60) Provisional application No. 63/357,343, filed on Jun. 30, 2022.

(51) Int. Cl. E21B 47/10; E21B 33/03

(52) U.S. Cl. CPC E21B 47/10; E21B 33/03

(57) ABSTRACT

The embodiments disclose a leak detection and remediation capping system for a wellhead including a plurality of sensors in close proximity to the wellhead configured to collect leakage information of a fluid from the wellhead, a quantification device coupled to the plurality of sensors configured to measure and convert the leakage information into quantifiable data, a GPS device coupled to the quantification device configured to record a location of the wellhead, an oil and gas database coupled to the wellhead and configured to store the quantifiable data, carbon credit qualification criteria and carbon credit sources, and a computer coupled to the oil and gas database and configured to compare the quantifiable data to the carbon credit qualification criteria to determine carbon credit qualifications of the remediation capping system and to identify carbon credit sources appropriate for the remediation capping system.

### CROSS-REFERENCED TO RELATED APPLICATIONS

This Patent Application is based on U.S. Provisional Patent Application Ser. No. 63/357,343 filed Jun. 30, 2022, entitled “SUSTAINABLE DEVELOPMENT GOALS FOR CARBON CREDITS METHODS AND DEVICES”, by Talal Atif Debs, the U.S. Patent Application being incorporated herein by reference.

### BACKGROUND

For deep greenhouse gas emission reductions, a long-term perspective on oil and gas wellhead detection and remediation is essential. However, it is challenging to locate oil and gas wells that are orphaned or have been abandoned to reduce greenhouse gas emissions.

### BRIEF SUMMARY OF THE INVENTION

One embodiment of the invention includes a leak detection and remediation capping system for a wellhead, comprising a plurality of sensors in close proximity to the wellhead configured to gather leakage information of fluid from the wellhead, a quantification device coupled to the plurality of sensors configured to measure and convert the leakage information into quantifiable data and a GPS device coupled to the quantification device configured to record a location of the wellhead. This information is used to remediate the leaking wellhead to reduce carbon emissions.

In one embodiment, orphaned oil and gas wells that are inactive, unplugged, and have no solvent owner of record are located for plugging and remediation. These wells, which have no solvent owner of record, can leak oil, gas, and other toxic chemicals into the air and water. Plugging these wells will protect the environment, climate, and communities while creating well-paying, stable jobs. This invention is a system to locate the wells and employs sensors to detect and identify the chemicals being leaked.

Additional devices are used to quantify the volume of any leakage from the well. The leakage is evaluated to determine the equipment to cap and plug the well structure to stop the leaks. The invention system further identifies programs that will provide financial support to build the remediation project to stop the leakage. This invention system will improve the environment and reduce health issues in the population from contact with toxic chemicals being leaked.

### BRIEF DESCRIPTION OF THE DRAWINGS

FIG. 1 shows for illustrative purposes only an example of orphaned gas wellhead leaking GHG into the air of one embodiment.

FIG. 2 shows for illustrative purposes only an example of orphaned gas wellhead database data collection and determinations of one embodiment.

FIG. 3 shows for illustrative purposes only an example of an orphaned oil wellhead leaking oil of one embodiment.

FIG. 4 shows a block diagram of an overview of offset and non-offset SDG points sources of one embodiment.

FIG. 5 shows a block diagram of an overview of potential carbon credit sources of one embodiment.

FIG. 6 shows a block diagram of an overview flow chart identifying high-quality emission reduction opportunities of one embodiment.

FIG. 7 shows a block diagram of an overview of analyzing high-quality emission reduction opportunities of one embodiment.

FIG. 8 shows for illustrative purposes only an example of sustainable development goals (SDGs) points of one embodiment.

FIG. 9 shows for illustrative purposes only an example of filtering out the greatest emission reduction opportunities of one embodiment.

FIG. 10 shows a block diagram of an overview of high-quality emission reduction opportunities in orphaned oil and gas wells of one embodiment.

FIG. 11 shows a block diagram of an overview of assessing landfill gas (LFG) methane emissions of one embodiment.

FIG. 12 shows a block diagram of an overview of quantifying the amount of emissions reduced of one embodiment.

FIG. 13 shows for illustrative purposes only an example of identifying and locating orphaned oil and gas wellheads of one embodiment.

FIG. 14 shows a block diagram of an overview of the remediation project impact of one embodiment.

FIG. 15 shows a block diagram of an overview of a carbon credits management system of one embodiment.

FIG. 16 shows a block diagram of an overview of cost-effective and feasible emission reduction devices of one embodiment.

FIG. 17 shows a block diagram of an overview of the environmental impacts of a remediation project of one embodiment.

FIG. 18 shows a block diagram of an overview of the partial remediation device of one embodiment.

### DETAILED DESCRIPTION OF THE INVENTION

In the following description, reference is made to the accompanying drawings, which form a part hereof, and which are shown by way of illustration a specific example in which the invention may be practiced. It is to be understood that other embodiments may be utilized, and structural changes may be made without departing from the scope of the present invention.

### General Overview:

It should be noted that the descriptions that follow, for example, in terms of a wellhead leak detection and remediation capping system, are described for illustrative purposes and the underlying system can apply to any number and multiple types of pollution remediation projects. In one embodiment of the present invention, the wellhead leak detection and remediation capping system can be configured using multiple detection sensors and quantification devices. The wellhead leak detection and remediation capping system can be configured to include greenhouse gases atmospheric emissions reduction and can be configured to include oil contamination of soil and water supplies reductions using the present invention.

The term used herein “orphaned” refers to oil and gas wells that are inactive, unplugged, and have no solvent owner of record. The term used herein “abandoned” refers to an oil or gas well that is plugged and abandoned when it reaches the end of its useful life or becomes a dry hole and has a solvent owner of record. The term used herein “well conductor” refers to a pipe drilled into the ground to a subterranean oil or gas field to convey the oil or gas to the surface.

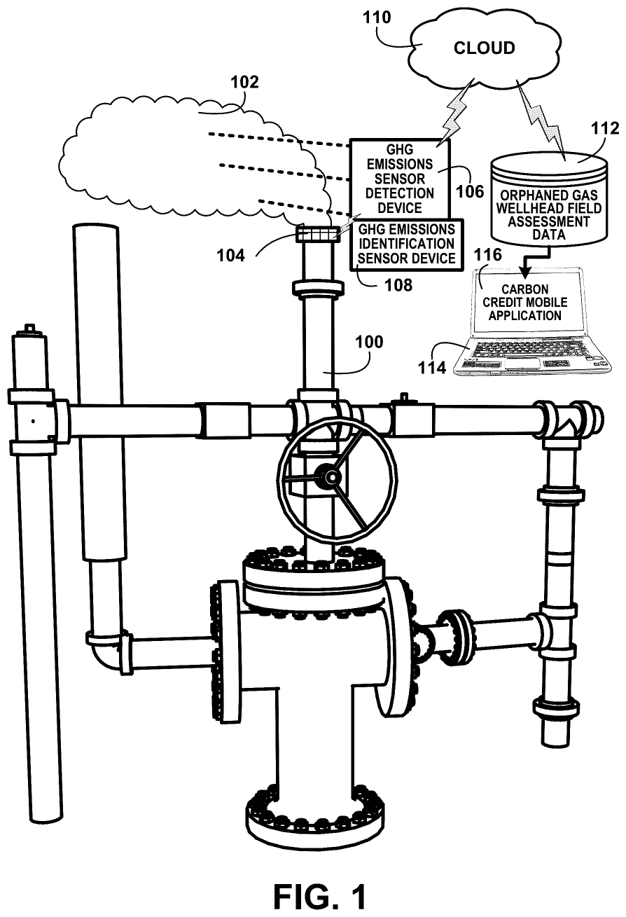

FIG. 1 shows for illustrative purposes only an example of orphaned gas wellhead leaking GHG into the air of one embodiment. FIG. 1 shows an orphaned gas wellhead 100 leaking greenhouse gases (GHGs) 102. A remediation quantification device 104 measures the quantity of the gas leakage. A GHG emissions sensor detection device 106 has at least one GHG emissions identification sensor device 108 to detect and identify one or more gases in the leaking gas. The quantity of the gas leakage and identified gases is used to qualify for sustainable development goals (SDGs) points and carbon credits. The quantity of the gas leakage and identified gas detection data is transmitted to a wireless network system, such as a cloud 110, and stored in an orphaned gas wellhead field assessment database 112.

A computer 114 processes the quantity of the gas leakage and identified gases detection data in a carbon credit mobile application 116. Computer 114 selects an offset carbon credit source to monetize a remediation project to cap and stop the leak of the orphaned gas wellhead 100 of one embodiment.

### DETAILED DESCRIPTION

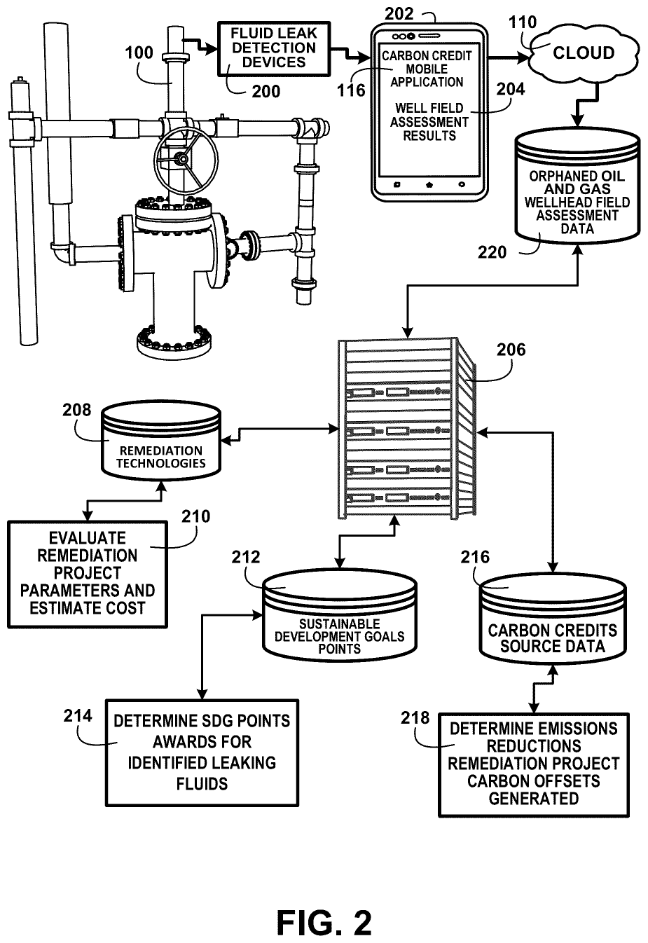

FIG. 2 shows for illustrative purposes only, an example of orphaned gas wellhead database data collection and determinations of one embodiment. FIG. 2 shows the orphaned gas wellhead 100 during a field assessment using fluid leak detection devices 200. The fluid leak detection devices 200 transmit the detection results to a user's mobile device 202. The user's mobile device 202 has the carbon credit mobile application 116 to display well-field assessment results 204. The well field assessment results 204 are transmitted with the carbon credit mobile application 116 to the cloud 110.

The cloud 110 relays the results for storage on an orphaned oil and gas wellhead field assessment data 220 database. The orphaned oil and gas wellhead field assessment data 220 database is coupled to server 206. Server 206 includes a plurality of databases to store data on multiple factors related to the wellhead remediation.

In one embodiment, at least one database stores information on remediation technologies 208. The information stored in the remediation technologies 208 database is coupled to server 206. The remediation technologies 208 database is used to evaluate remediation project parameters and estimate cost 210 based on the orphaned oil and gas wellhead field assessment data 220 in an interprocess.

A sustainable development goals points 212 database is coupled to the server 206. The sustainable development goals points 212 database provides data used to determine SDG points awards for identified leaking fluids 214 based on the orphaned oil and gas wellhead field assessment data 220 in an interprocess. A carbon credits source data 216 database is coupled to server 206. The carbon credits source data 216 database stores information used to determine emissions reduction remediation project carbon offsets generated 218 based on the orphaned oil and gas wellhead field assessment data 220 in an interprocess of one embodiment.

### Orphaned Oil Wellhead Leaking Oil:

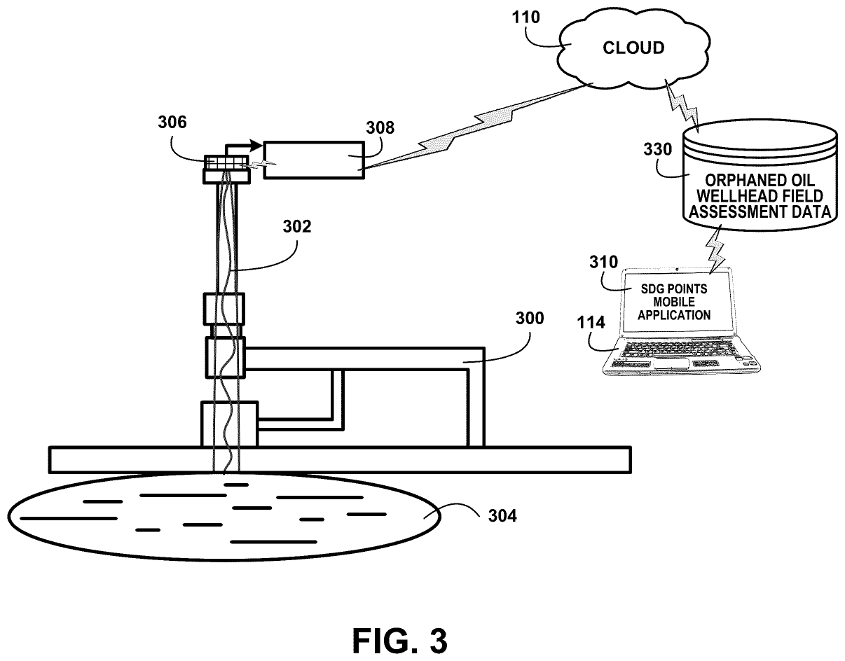

FIG. 3 shows for illustrative purposes only an example of an orphaned oil wellhead leaking oil of one embodiment. FIG. 3 shows an orphaned oil wellhead 300 having oil leaking 302 from the uncapped wellhead. The leaking oil is pooling on the ground and leaching into the soil 304. The leaking oil leaching into the soil 304 causes pollution of the environment. A remediation oil quantification device 306 measures the quantity of oil being released from the uncapped orphaned oil wellhead 300. At least one oil chemical sensor detection device 308 receives the quantity measured by the remediation oil quantification device 306. At least one oil chemical sensor detection device 308 detects and identifies the chemical components of the leaking oil to determine the potential contamination of the soil and environment.

The measured quantity and sensor-detected chemicals data are transmitted to cloud 110 and stored on an orphaned oil wellhead field assessment data 330 database for the orphaned oil wellhead 300. A computer 114 processes the data with an SDG points remote application, such as a mobile application 310. The SDG points mobile application 310 determines the number of SDG points not associated with any carbon offsets available for the orphaned oil wellhead 300 remediation. SDG points not associated with any carbon offsets include externality data not directly measurable in the field, for example, employment uplift, inclusivity, and benefits to communities other than reduced air pollution of one embodiment.

### Offset and Non-Offset SDG Points:

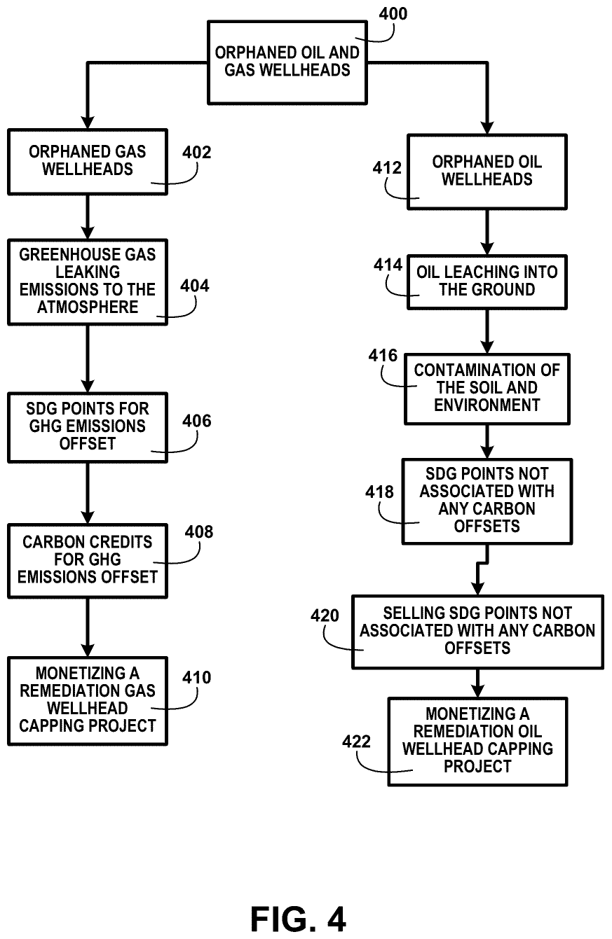

FIG. 4 shows a block diagram of an overview of offset and non-offset SDG points sources of one embodiment. FIG. 4 shows targeted orphaned oil and gas wellheads 400 remediation projects. Orphaned gas wellheads 402 present greenhouse gas leaking emissions to the atmosphere 404. SDG points for GHG emissions offset 406 are provided for air pollution reduction. The SDG points qualify for carbon credits for a GHG emission offset 408. Industries that cannot economically cut carbon emissions or can only partially cut carbon emissions purchase offset carbon credits to reach their carbon emissions reduction goals.

Orphaned gas wellheads 402 remediation projects create carbon offsets. The carbon offsets are sold as carbon credits for monetizing a remediation gas wellhead capping project 410. Orphaned oil wellheads 412 leaking oil are not associated with offsets for atmospheric pollution. Orphaned oil wellheads 412 are leaking oil wherein oil leaching into the ground 414 causes contamination of the soil and environment 416. SDG points not associated with any carbon offsets 418 are available. Selling SDG points not associated with any carbon offsets 420 are used for monetizing a remediation oil wellhead capping project 422.

In one embodiment, a detection device includes a plurality of sensors wirelessly coupled to a network server 206 of FIG. 2 configured to detect and quantify fluid emissions from orphaned oil and gas wells 400 to establish baseline emissions. A baseline emissions verification program wirelessly coupled to a network server 206 of FIG. 2 is configured to use a licensed third party to audit and certify that the project meets all applicable criteria for issuance of offsets. A plurality of advanced technologies is configured to prepare and plug each well to ensure that no emissions can escape in accordance with applicable regulations and standards. The advanced technologies include a cement pumper to fill a well conductor with cement to plug the well and stop the flow of a fluid creating the leakage.

A plurality of reclamation devices is configured to remove all wellhead physical equipment and reclaim a wellbore site. A plurality of decommissioning devices is wirelessly coupled to a network server 206 of FIG. 2 and configured to perform final assessments to ensure there are no leaks and that all deliverables have been satisfied. The baseline emissions verification program wirelessly coupled to a network server 206 of FIG. 2 is configured to generate a complete review of the remediation effort.

The baseline emissions verification program includes a site visit by the licensed third-party Verifying/Validating Body to certify the issuance of the appropriate number of offsets. An offset retirement program wirelessly coupled to a network server 206 of FIG. 2 is configured to remove from circulation offsets to allow holders of offsets to use them and claim the associated greenhouse gas (“GHG”) reductions towards a GHG reduction or net zero goal of one embodiment.

### Researching Potential Carbon Credit Sources:

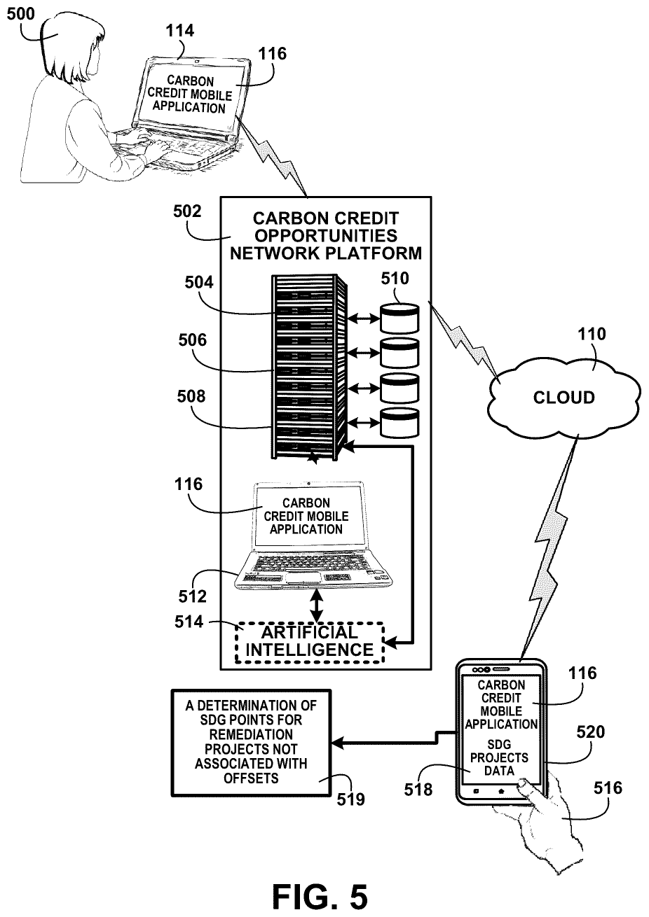

FIG. 5 shows a block diagram of an overview of researching potential carbon credit sources of one embodiment. FIG. 5 shows a user 500 utilizing a computer 114 having a carbon credit mobile application 116 to review data. The User 500 may remotely gather potential carbon credit sources from a carbon credit opportunities network platform 502. The carbon credit opportunities network platform 502 includes a plurality of digital servers 504, a plurality of analyzers 506, a plurality of processors 508, a plurality of databases 510, a platform computer 512 having the carbon credit mobile application 116, and an artificial intelligence device 514.

A user in the field 516 may gather SDG projects data 518 on a user's smartphone 520 having the carbon credit mobile application 116. The SDG projects data 518 is transmitted wirelessly to a cloud 110 to store the SDG projects data 518 on at least one of the plurality of databases 510. At least one database stored SDG projects data 518 is reviewed by the user 500 for potential carbon credit sources.

A processor is used to analyze carbon credit source data to determine matches with the SDG projects data 518. The matching process includes a determination of SDG points for remediation projects not associated with offsets 519. In one embodiment, an analyzer is used to identify carbon credit sources fitting an offset obligation. The identification analysis includes a GPS location, the current condition of the facility, and the make-up of the emission gases, stakeholders, and potential remediation. In one embodiment, a processor is used to track a carbon credit status including emissions volumes, carbon credit pricing, and potential environmental attribution benefits.

An analyzer is used to determine the risks of the carbon credit source remediation and to make recommendations. Remediation potential is assessed as a key feature of the suitability of orphaned well projects. The project structure is carefully considered with an emphasis on risk mitigation. A processor is used to manage the marketing of the carbon credits. An analyzer is used to assess opportunities related to regulatory bodies and governmental oversight groups, such as the United Nations' numerous goals, as sustainable development goals (SDG) of one embodiment. In one embodiment, SDG points can be created as quantifiable units in general against objective criteria and are offered in quantities of greenhouse gases SDG points per tonne (metric ton). In one embodiment, the total carbon reduction with a $5 point value is applied to the reduction of emissions of all greenhouse gases.

The SDG point quantifiable units, in one embodiment, can be non-fungible tokens (NFTs) that do not change in units but can change in value. In another embodiment, the SDG point quantifiable units can be fungible tokens that may change in characteristics and also change in value. An SDG point will represent the economic externality associated with activities that achieve SDG goals. This is an analogy to carbon credits or other emission credits but addresses a much more holistic set of possible “social good” outcomes of one embodiment.

Carbon offsets will continue to be in high demand, given all the Net Zero commitments. The SEC potentially regulates Scope 3 emissions. Scope 3 emissions are indirect emissions that result from activities related to a company. Indirect emissions activities are not owned or controlled by the company. Scope 3 emissions can come from various sources, including the production and transportation of materials, waste disposal, employee commuting, and the use of company-owned vehicles.

End-of-life services are provided in one example, for industrial oil and gas operations that currently or potentially emit harmful greenhouse gas (GHG) emissions, specifically methane released from orphaned oil and gas wells or associated midstream assets. The stakeholders are currently burdened with these GHG emissions and their associated liabilities. Key stakeholders will include local, state, and federal bodies with responsibility for managing the orphaned oil and gas wells. Other key stakeholders include current owners and operators of abandoned oil and gas wells.

In one embodiment, the disclosed invention provides solutions to end the orphaned oil and gas wells harmful greenhouse gas (GHG) emissions. The emission-ending solutions include activities across crucial areas. Crucial areas include finding and remediating the most highly polluting orphaned oil and gas wells and deploying a comprehensive suite of end-of-life services for owners of abandoned wells. Implementing best execution for plugging and decommissioning services, including the deployment of existing and novel technologies to create and maintain transparent key performance indicators (KPIs). Where applicable, end-of-life services include developing the means to defray costs through the issuance of and marketing of relevant environmental attributes, including voluntary emission reductions (VERS) and other similar voluntary, compliance, or tax-based incentives.

The end-of-life service solutions address this highly significant environmental challenge while also achieving relevant UN sustainable development goals (SDGs) in a well-documented and transparent manner. The commercial goal of the wellhead leak detection and remediation capping system is to address the end-of-life oilfield service challenge in a way that reduces costs and Environmental, Social, and Governance (ESG) burden to corporations and communities while generating requisite investment returns for shareholders.

### Identifying High-Quality Emission Reduction Opportunities:

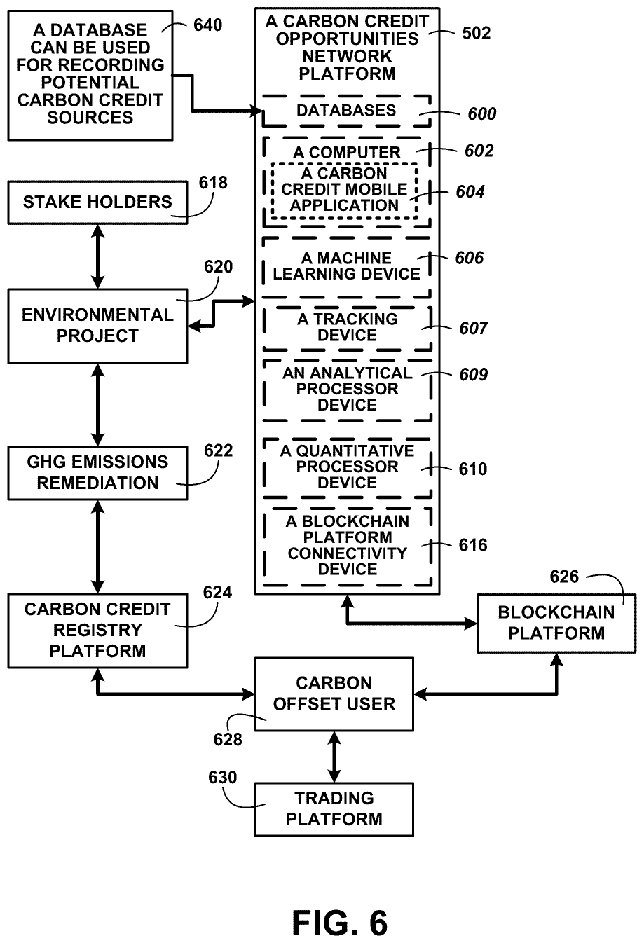

FIG. 6 shows a block diagram of an overview flow chart identifying high-quality emission reduction opportunities of one embodiment. FIG. 6 shows a carbon credit opportunities network platform 502. The carbon credit opportunities network platform 502 includes databases 600 for recording high-quality emission reduction opportunities data. The computer 602 with a carbon credit mobile application 604 receives, transmits, and processes high-quality emission reduction opportunities data. Machine learning device 606 software tools are used to update the data in the evolving Voluntary Carbon Market. A tracking device 607 is used for tracking potential carbon credit sources remediation potential status and emissions chemicals.

A database device for recording potential carbon credit sources 610. An analytical processor device 609 is used for analyzing and identifying high-quality emission reduction opportunities. A qualitative processor device 610 is used for preparing an assessment of high-quality emission reduction opportunities factors. A blockchain platform connectivity device 616 is used for marketing carbon credit opportunities. The identification of the high-quality emission reduction opportunities includes the stakeholders 618, gases being emitted, and the type of facility for the environmental projects 620.

GHG emissions remediation 622 is analyzed, cost estimated, and risk assessed. The analyses and identification information are registered on a carbon credit registry platform 624. The marketing of the carbon credits and SDG credits are entered on a blockchain platform 626. A carbon offset user 628 can review the credits information on the carbon credit registry platform 624. The carbon offset user 628 can purchase the credits on the blockchain platform 626 and a trading platform 630. Marketing provides exposure to a market that is showing significant growth. The growth provides leverage to increase carbon credit prices worldwide. The ability to purchase carbon credits provides portfolio diversification because carbon credits have a low correlation to other asset classes. Pioneering methodologies for carbon projects and successfully executing and delivering high-quality carbon offsets are the methods and goals of this invention of one embodiment.

Calculating the value in points for high-quality emission reduction opportunities involves several variables that need to be considered. Some of the variables include GHG emissions, implementation costs, technical feasibility, environmental and social co-benefits, and additionality. GHG emissions include reduction potential that is the amount of greenhouse gas emissions that can be avoided or reduced through the implementation of the opportunity. This variable can be valued based on the current market price of carbon, which is typically determined through the trading of carbon credits on various carbon markets.

Implementation costs include the expenses associated with implementing the emission reduction opportunity, such as capital costs, operational costs, and maintenance costs. This variable can be valued by estimating the total cost of implementing the opportunity and then subtracting any expected savings or revenue generated from the opportunity. Technical feasibility refers to the likelihood that the opportunity can be successfully implemented and operated. This variable can be valued based on the level of risk associated with the technology or risk solutions being implemented. The higher the level of risk, the lower the valuation of this variable. Environmental and social co-benefits are the additional benefits that may result from implementing the opportunity.

The additional benefits include improved air quality, increased biodiversity, and improved social well-being. This variable can be valued based on the estimated monetary value of these co-benefits, which can be determined through various valuation methodologies. Additionally refers to the extent to which the opportunity goes beyond business-as-usual practices.

Going beyond business-as-usual practices means that it would not have been implemented without additional incentives or support. This variable can be valued based on the level of additional effort required to implement the opportunity compared to business-as-usual practices. Once the values of these variables have been estimated, they can be used to determine the value in points for the emission reduction opportunity. The exact method for calculating the value in points may vary depending on the specific program or framework being used. Generally, calculating the value in points involves assigning a point value to each variable and then summing the total points to arrive at a final score.

### Analyzing High-Quality Emission Reduction Opportunities:

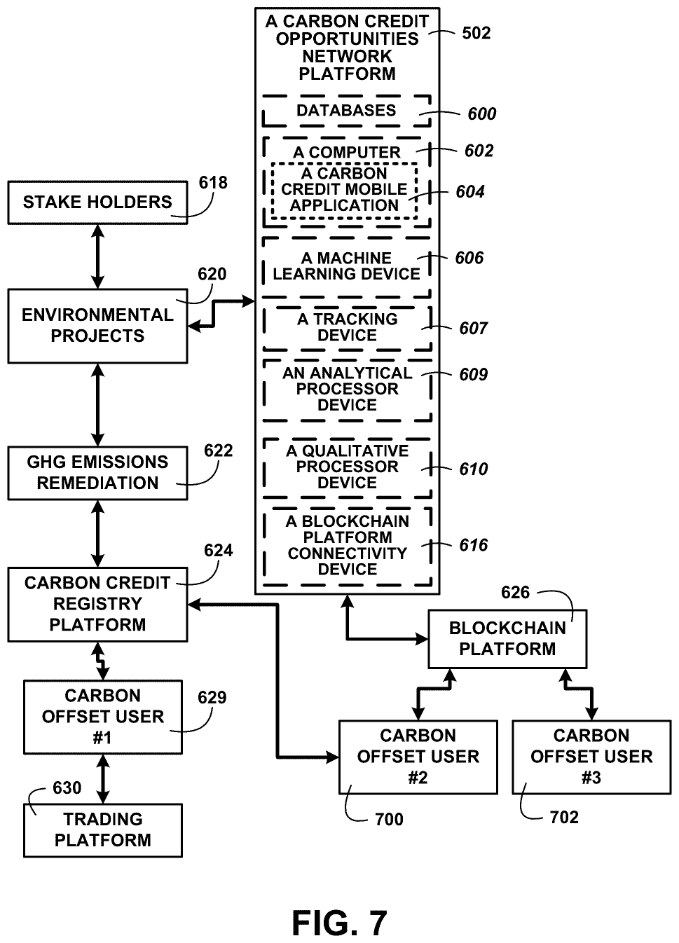

FIG. 7 shows a block diagram of an overview of analyzing high-quality emission reduction opportunities of one embodiment. FIG. 7 shows a carbon credit opportunities network platform 502 including databases 600, a computer 602 with a carbon credit application 604, and a machine learning device 606. A tracking device 607 can be included for tracking potential carbon credit sources remediation potential status and emissions chemicals 608. An analytical processor device 609 for analyzing and identifying high-quality emission reduction opportunities. A qualitative processor device 610 is used for preparing an assessment of high-quality emission reduction opportunities factors. A blockchain platform connectivity device 616 is used for marketing carbon credit opportunities.

A blockchain platform 626 can be used for marketing carbon credit opportunities. The blockchain platform 626 provides an active market for stakeholders 618 to recover costs for environmental projects 620 GHG emissions remediation 622. The carbon credits and SDGs are entered on a carbon credit registry platform 624. A carbon offset user #1 629 can acquire the credits on a trading platform 630 and the blockchain platform 626.

In one embodiment, a database can be used for recording potential carbon credit sources 640, GPS location, stakeholders, and identification of GHG emissions compile the data. Carbon offset user #2 700 and carbon offset user #3 702 can check the carbon credit registry platform 626 and purchase the credits they need on the blockchain platform 626.

An analytical processor device 609 is used for analyzing and identifying high-quality emission reduction opportunities including potential risk, remediation, risk mitigation, and potential environmental attribution benefits. A qualitative processor device 610 is used for preparing an assessment of project and methodology risk, broader community social benefits, project economics, and potential investment structures. A tracking device 607 is used for tracking potential carbon credit sources remediation potential status and emissions chemicals and volumes, and environmental impacts. An analytical processor device 609 is used for registering potential high-quality projects on a carbon registry.

A data management device is used for tracking carbon markets and determining enhancement and marketing of relevant environmental attributes including VERS, tax-based incentives, and sustainable development goal points. An analytical processor device 609 is used for determining community social benefits. Facilitating the commercial operating system of end-of-life oilfield service projects is accomplished by connecting disparate data stores, and execution of real-time audits and carbon credit authentications of one embodiment.

### Sustainable Development Goals Example

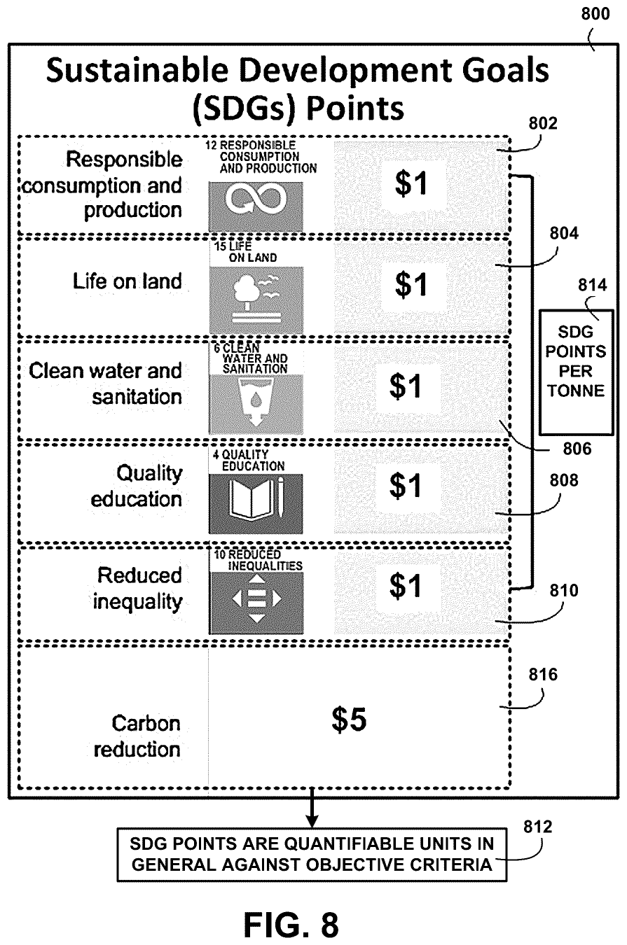

FIG. 8 shows for illustrative purposes only an example of sustainable development goals (SDGs) points of one embodiment. FIG. 8 shows examples of sustainable development goals (SDGs) points 800 available for credits for the high-quality emission reduction opportunities that have been identified and developed. A responsible consumption and production project is found in SDG #12 valued at $1 point 802. Life on land benefits are offered with SDG #15 with a $1 point 804. Clean water and sanitation achieved benefits fulfill SDG #6 with a $1 point 806. Quality education goals met are found in SDG #4 with a $1 point 808.

Reduced inequality results are the goal of SDG #10 with a $1 point 810 value. SDG points are quantifiable units, in general, measured against objective criteria 812 and are offered in quantities of greenhouse gases SDG points per tonne 814 (metric ton). The total carbon reduction with a $5 point 816 value applies to the reduction of emissions of all greenhouse gases. The SDG points quantifiable units, in one embodiment, can be non-fungible tokens (NFTs) that do not change in units but can change in value. In another embodiment, SDG points quantifiable units can be fungible tokens that may change in characteristics and also change in value. An SDG point will represent the economic externality associated with activities that achieve SDG goals. SDG points are analogous to carbon credits or other emission credits but address a much more holistic set of possible “social good” outcomes of one embodiment.

### Filtering Out the Greatest Emission Reduction Opportunities:

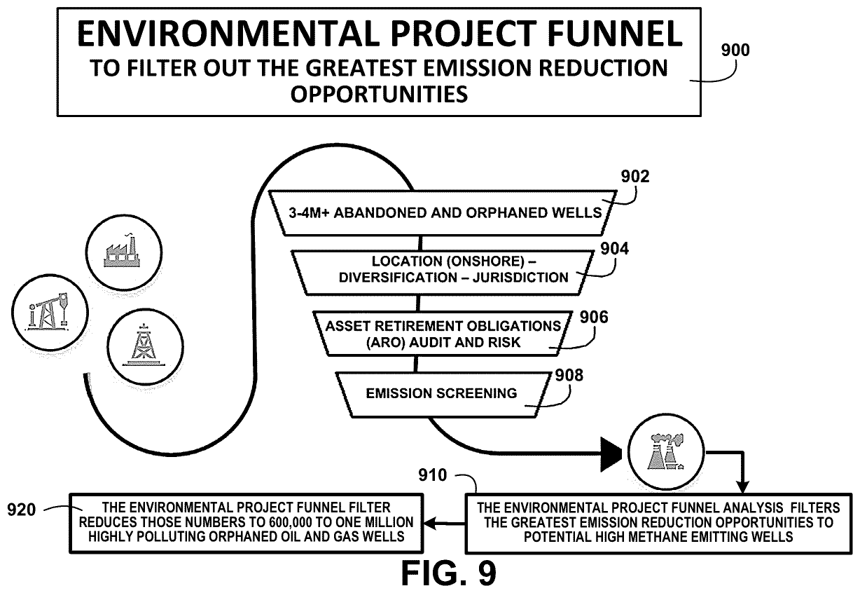

FIG. 9 shows for illustrative purposes only an example of filtering out the greatest emission reduction opportunities of one embodiment. FIG. 9 shows an environmental project funnel to filter out the greatest emission reduction opportunities 900. The funnel analyses factors that lead to high emission reduction at economical costs and low risk. In the U.S., there are millions of orphaned and abandoned wells 902. These orphaned and abandoned wells have a location (onshore) with diversification and jurisdiction 904. The diversification is available as to the type of facility, gases being emitted, and state and local jurisdictions which can affect costs and timing. Asset retirement obligations (ARO) audit and risk 906 may be regulated by the jurisdiction as well as federal regulations. This can impact remediation costs. Emission screening 908 analyzes the type of gas and emission volumes. The environmental project funnel analysis filters the greatest emission reduction opportunities to potential high methane emitting wells 910 of one embodiment.

In this example, the emission-ending solution activity is used for finding and remediating the most highly polluting orphaned oil and gas wells and is facilitated with the use of the innovative and effective environmental project funnel filter. The identification and remediation of the highly polluting orphaned wells stage are used to narrow the shorter-term efforts to those emissions-ending activities to reach a higher environmental benefit. In one embodiment, the population of orphaned wells is estimated between three and four million wells. In this embodiment, the environmental project funnel filter reduces those numbers to 600,000 to one million highly polluting orphaned oil and gas wells 920.

Initially, the activities work to identify what are high-quality emission reduction opportunities in orphaned oil and gas well based on an assessment of project and methodology risk, broader community social benefits (including the UN SDGs), project economics, and potential investment structures. The most highly polluted wells are targeted to maximize community social benefits and potential environmental attribution benefits. The project assessments include a multitude of factors when selecting suitable high-quality projects and the following describes a few of such factors. Beyond a strict financial analysis, all projects are assessed concerning an Environmental, Social, and Governance Policy. It further includes projects assessed against the United Nations' seventeen (17) sustainable development goals, which are followed and observed.

Assessing potential projects against the ESG Policy is determinative when selecting high-quality projects. Remediation potential is assessed as a key feature of the suitability of orphaned well projects. The project structure is carefully considered with an emphasis on risk mitigation. Due diligence is conducted on all project development aspects and participants. The environmental project funnel filter results feed into an identified potential project pipeline of potential high-quality projects which may be pursued.

The identification of the greatest emission reduction opportunities is followed by deploying a comprehensive suite of end-of-life services for owners of abandoned wells. The deployment utilizes expertise to provide services for owners of abandoned wells. This includes the financing of plugging and abandonment, measurement and assessment of environmental liabilities, plugging of the wellbore, and the remediation of the site.

### High-Quality Emission Reduction Opportunities in Orphaned Oil and Qas Wells:

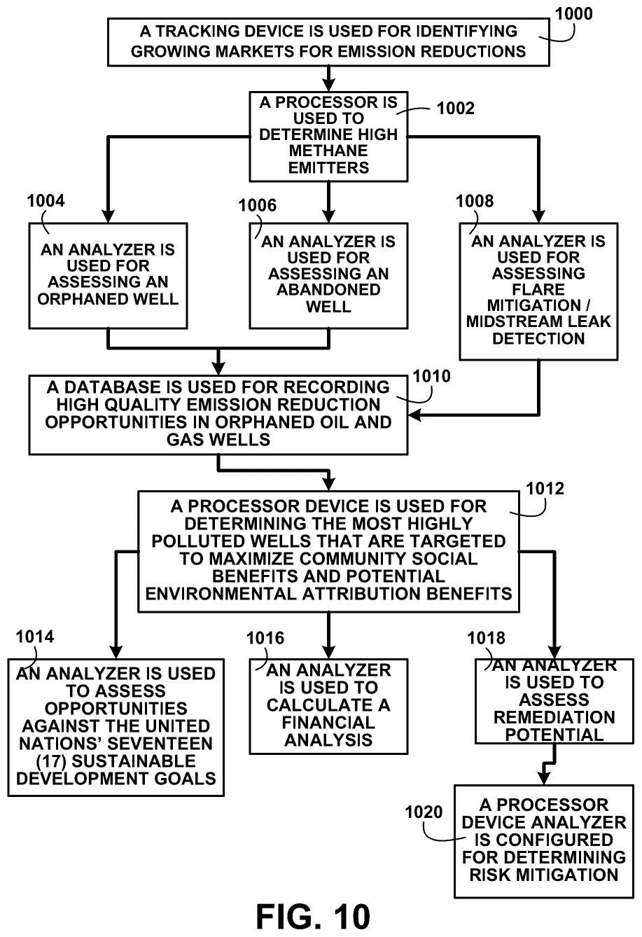

FIG. 10 shows a block diagram of an overview of high-quality emission reduction opportunities in orphaned oil and gas wells of one embodiment. FIG. 10 shows a tracking device used for identifying growing markets for emission reductions 1000. A processor is used to determine high methane emitters 1002. An analyzer is used for assessing an orphaned well 1004 emissions status. An analyzer is used for assessing an abandoned well 1006. An analyzer is used for assessing flare mitigation/midstream leak detection 1008 emissions status. Gas flaring is the burning of natural gas associated with oil extraction.

A database is used for recording high-quality emission reduction opportunities in orphaned oil and gas wells 1010. A processor device is used for determining the most highly polluted wells that are targeted to maximize community social benefits and potential environmental attribution benefits 1012. An analyzer is used to assess opportunities against the United Nations' seventeen (17) sustainable development goals 1014. An analyzer is used to calculate a financial analysis 1016. An analyzer is used to assess remediation potential 1018. A processor device analyzer is used for determining risk mitigation 1020 of one embodiment.

Risk mitigation is assessed with an analysis of implementing the best execution for all plugging and abandonment services. As part of the third area of end-of-life oilfield service project involvement, the emphasis is the implementation of existing and novel technologies, the creation and maintaining transparent KPls, and, where applicable development of means to defray costs through the issuance of, enhancement, and marketing of relevant environmental attributes, including Voluntary Emission Reductions (VERs) and other similar voluntary, compliance, or tax-based incentives.

In one embodiment, the goal is to facilitate the commercial operating system of end-of-life oilfield service projects by connecting disparate data stores, and execution of real-time audits and carbon credit authentications. The analysis includes the use of drone and satellite environment monitoring, data management, and machine learning software tools to enhance trust and verification in the evolving Voluntary Carbon Market.

### Assessing Landfill Gas (LFG) Methane Emissions:

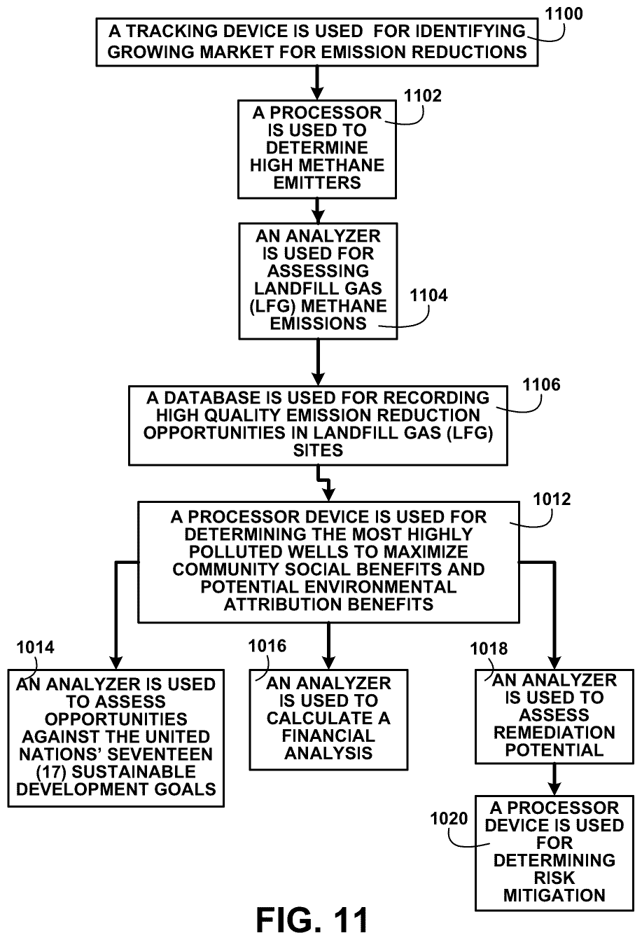

FIG. 11 shows a block diagram of an overview of assessing landfill gas (LFG) methane emissions of one embodiment. FIG. 11 shows a tracking device used for identifying the growing market for emission reductions 1100. A processor is used to determine high methane emitters 1102. An analyzer is used for assessing landfill gas (LFG) methane emissions 1104. A database is used for recording high-quality emission reduction opportunities in landfill gas sites 1106. A processor device is used for determining the most highly polluted wells to maximize community social benefits and potential environmental attribution benefits 1012. An analyzer is used to assess opportunities against the United Nations' seventeen (17) sustainable development goals 1014. An analyzer is used to calculate a financial analysis 1016. An analyzer is used to assess remediation potential 1018. A processor device is used for determining risk mitigation 1020 of one embodiment.

### Quantify the Amount of Emissions Reduced:

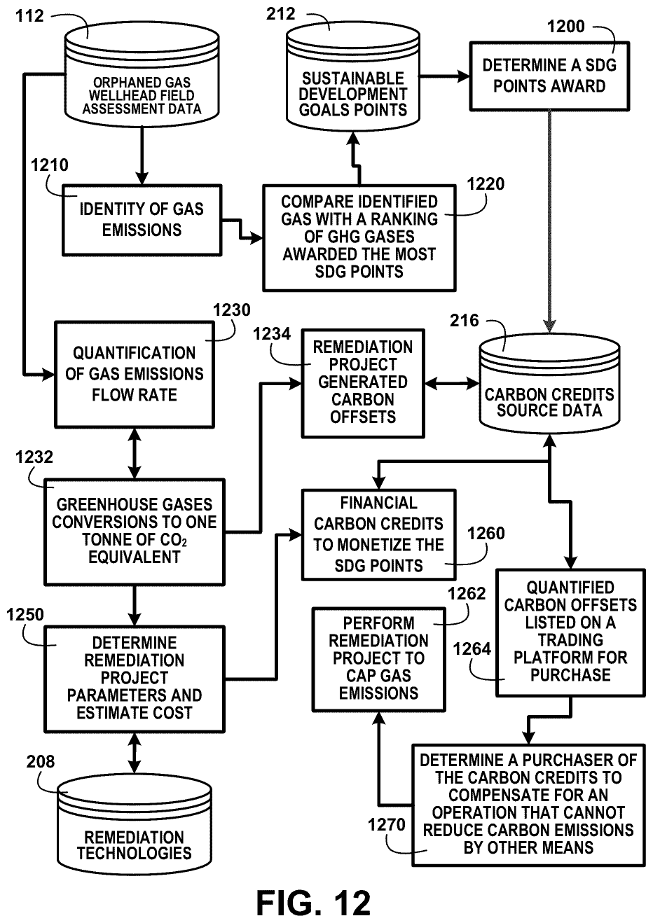

FIG. 12 shows a block diagram of an overview of quantifying the amount of emissions reduced of one embodiment. FIG. 12 shows the orphaned gas wellhead field assessment data 112 database providing an identity of gas emissions 1210 data for an interprocess to compare identified gas with a ranking of GHG gases awarded the most SDG points 1220 based on data from the sustainable development goals points 212 database.

The orphaned gas wellhead field assessment data 112 database further provides quantification of gas emissions flow rate 1230 data in an interprocess for greenhouse gases conversions to one tonne of CO₂ equivalent 1232 for carbon credit valuations. The orphaned gas wellhead field assessment data 112 database further provides data to determine remediation project parameters and estimated cost 1250 using data from the remediation technologies 208 database in an interprocess. At least one remediation device is used to retrofit an existing facility with renewable energy sources that will earn SDG 7 affordable and clean energy points.

The information stored in the sustainable development goals points 212 database is also used in a process to determine an SDG points award 1200. The SDG points award is used with data from the carbon credits source data 216 database and the calculated remediation project generated carbon offsets 1234 based on the interprocess for greenhouse gases conversions to one tonne of CO₂ equivalent 1232 to determine the value of carbon credits available.

The results from the interprocess are used to determine remediation project parameters and estimate cost 1250 which are used to determine the financial carbon credits to monetize the SDG points 1260 based on the value of carbon credits available. The quantified carbon offsets listed on a trading platform for purchase 1264 is a process used to determine a purchaser of the carbon credits to compensate for an operation that cannot reduce carbon emissions by other means 1270. Selling the carbon credits will provide funding to perform remediation projects to cap gas emissions 1262 of one embodiment.

### Identifying and Locating Orphaned Oil and Gas Wellheads:

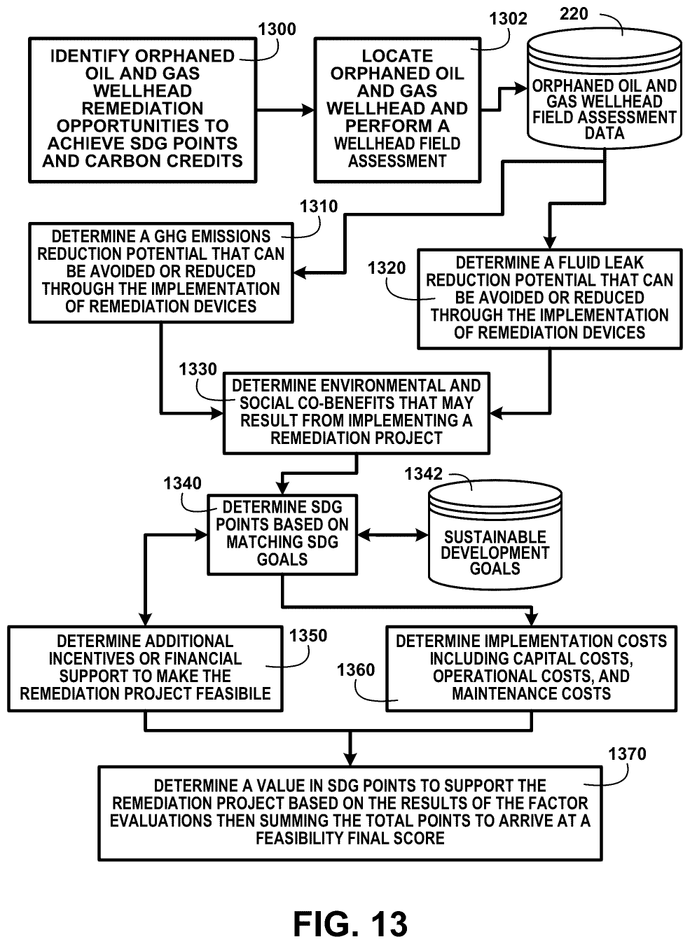

FIG. 13 shows for illustrative purposes only an example of identifying and locating orphaned oil and gas wellheads of one embodiment. FIG. 13 shows a process to identify orphaned oil and gas wellhead remediation opportunities to achieve SDG points and carbon credits 1300. The following process is used to locate an orphaned oil and gas wellhead and perform a wellhead field assessment 1302. A field assessment is performed for each identified and located oil and gas wellhead to determine a GHG emissions reduction potential that can be avoided or reduced through the implementation of remediation devices 1310.

Both processes store data on the orphaned oil and gas wellhead field assessment data 220 database. The field assessment is to determine a fluid leak reduction potential that can be avoided or reduced through the implementation of remediation devices 1320. An analysis is performed to determine environmental and social co-benefits that may result from implementing a remediation project 1330 to determine SDG points based on matching SDG goals 1340 based on the information in the sustainable development goals 1342 database.

Another analysis is performed to determine additional incentives or financial support to make the remediation project feasible 1350. A process to determine implementation costs including capital costs, operational costs, and maintenance costs 1360 is performed. These processes are used to determine a value in SDG points to support the remediation project based on the results of the factor evaluations then summing the total points to arrive at a feasibility final score 1370 of one embodiment.

### Remediation Project Impact:

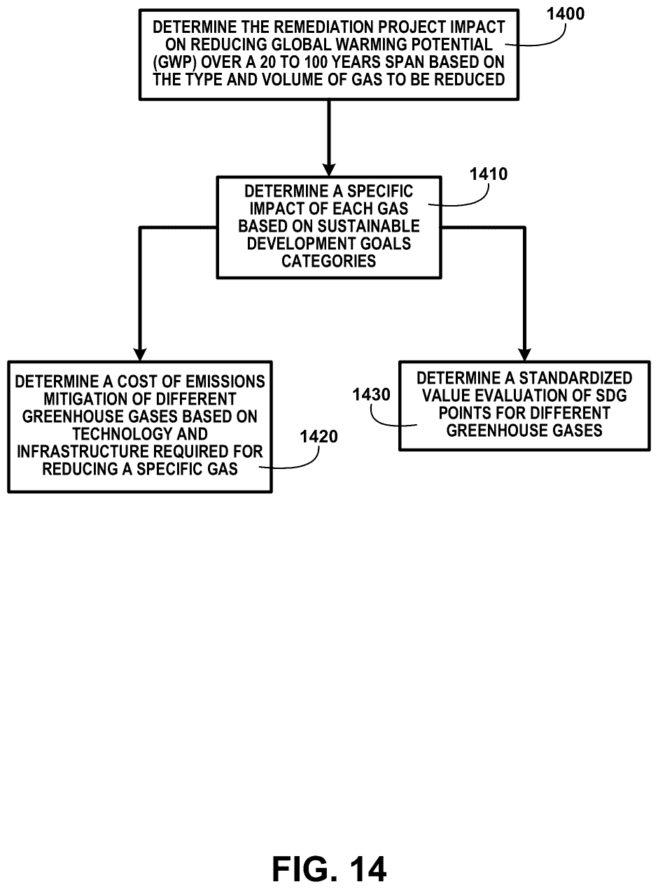

FIG. 14 shows a block diagram of an overview of the remediation project impact of one embodiment. FIG. 14 shows a process to determine the remediation project impact on reducing global warming potential (GWP) over a 20 to 100 years span based on the type and volume of gas to be reduced 1400. An analysis is made to determine the specific impact of each gas based on sustainable development goals categories 1410 including SDG 13 (climate action), SDG 14 (life below water), SDG 15 (life on land), and SDG 2 (zero hunger) in regions with high agricultural productivity. Another analysis is made to determine the cost of emissions mitigation of different greenhouse gases based on technology and infrastructure required for reducing a specific gas 1420. The processes combined are used to determine a standardized value evaluation of SDG points for different greenhouse gases 1430 of one embodiment.

### Carbon Credit Management:

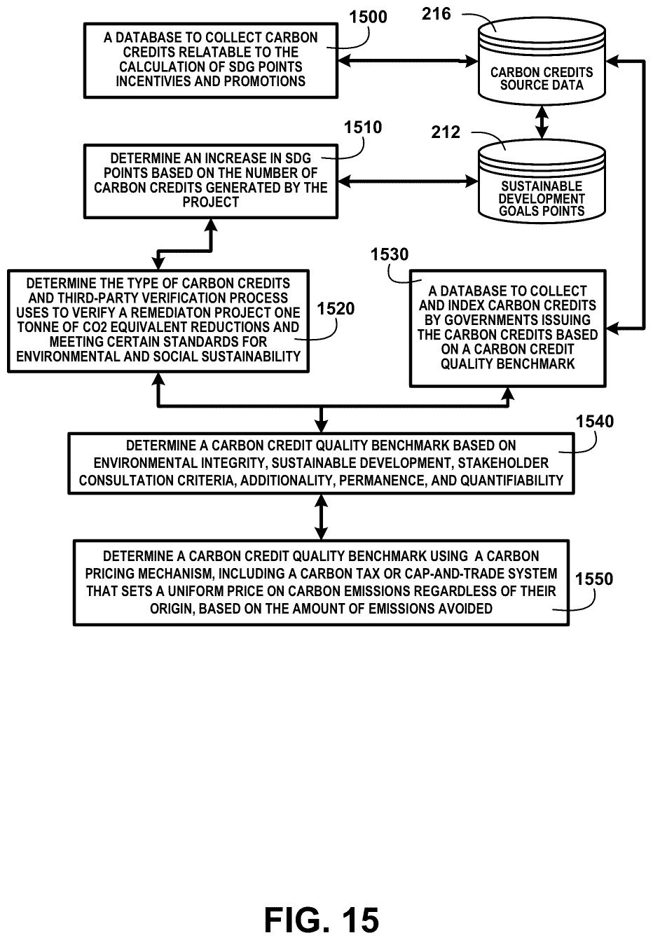

FIG. 15 shows a block diagram of an overview of a carbon credits management system of one embodiment. FIG. 15 shows a database to gather carbon credits relatable to the calculation of SDG points incentives and promotions 1500 and to store the same in a carbon credits data 216 database. A processor is used to determine an increase in SDG points based on the number of carbon credits generated by the project 1502 based on the sustainable development goals 212 database stored information. An analysis is performed to determine the type of carbon credits and third-party verification process used to verify the project one tonne of CO₂ equivalent reductions and meet certain standards for environmental and social sustainability 1504.

A database is used to gather and index carbon credits by governments issuing the carbon credits based on a carbon credit quality benchmark 1506. The indexing of carbon credits is based on information stored in the sustainable development goals 212 database. An analysis is made to determine a carbon credit quality benchmark based on environmental integrity, sustainable development, stakeholder consultation criteria, additionality, permanence, and quantifiability 1508.

Another analysis is used to determine a carbon credit quality benchmark using a carbon pricing mechanism, including a carbon tax or cap-and-trade system. The carbon pricing mechanism sets a uniform price on carbon emissions regardless of their origin based on the amount of emissions avoided 1510. The inclusion of carbon credits in the calculation of SDG points depends on the specific framework or program being used. Some programs or frameworks that focus on climate action, such as the Clean Development Mechanism (CDM) or the Verified Carbon Standard (VCS), may use carbon credits as a way to incentivize emission reductions and promote sustainable development.

Carbon credits are a type of tradable permit that represents the right to emit one tonne of CO₂ equivalent. They are generated through projects that reduce greenhouse gas emissions or remove carbon from the atmosphere and can be traded on carbon markets. When a project generates carbon credits, it is typically certified by a third-party verification process that ensures the project meets certain standards for environmental and social sustainability.

In the context of SDG points, the use of carbon credits may be one way to incentivize and reward emission reduction projects that contribute to SDGs. The specific calculation of SDG points may depend on the framework or program being used, but generally, the number of SDG points may increase based on the number of carbon credits generated by the project.

The variations in carbon credits issued by different governments may be balanced in the points by using a standardized methodology that accounts for the specific characteristics of each credit, such as the type of project, the location, the vintage (year of issuance), and the certification standard.

Another approach to balance the variations in carbon credits is to use a carbon pricing mechanism, such as a carbon tax or cap-and-trade system, which sets a uniform price on carbon emissions regardless of their origin. In this case, the SDG points awarded to emission reduction projects would be based on the amount of emissions avoided, rather than the type of carbon credit used.

The variations in carbon credits issued by different governments can be balanced in the points by using a standardized methodology that accounts for the specific characteristics of each credit and ensures compliance with a set of quality standards, or by using a carbon pricing mechanism that sets a uniform price on carbon emissions of one embodiment.

### Cost-Effective and Feasible Emission Reduction Devices:

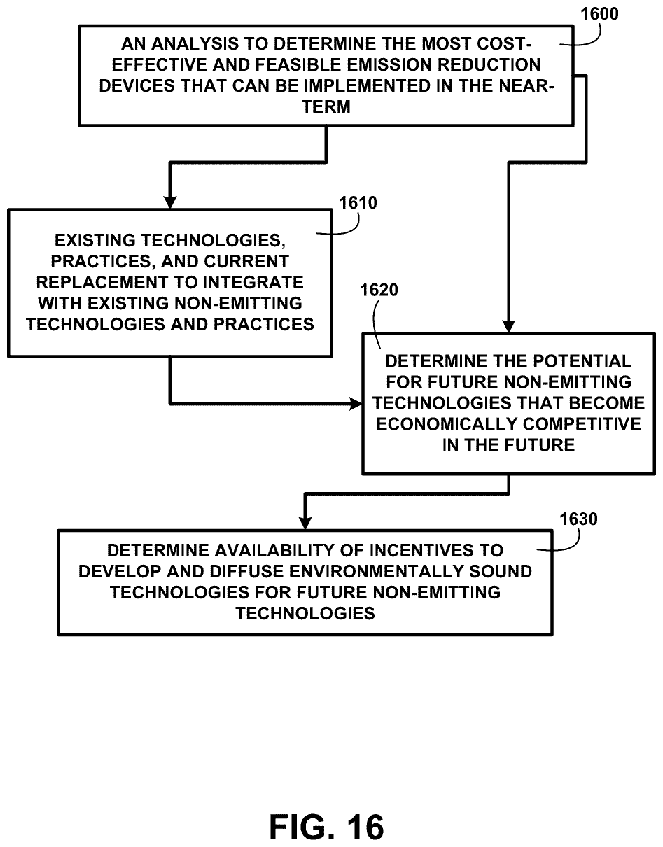

FIG. 16 shows a block diagram of an overview of cost-effective and feasible emission reduction devices of one embodiment. FIG. 16 shows an analysis used to determine the most cost-effective and feasible emission reduction devices that can be implemented in the near term 1600. The analysis used to determine the most cost-effective and feasible emission reduction devices compares existing technologies, practices, and current replacement with existing non-emitting technologies and practices 1610. An analyzer is used to determine the potential for future non-emitting technologies that become economically competitive in the future 1620. Another analyzer is used to determine the availability of incentives to develop and diffuse environmentally sound technologies for future non-emitting technologies 1630 of one embodiment.

### Environmental Impacts of a Remediation Project:

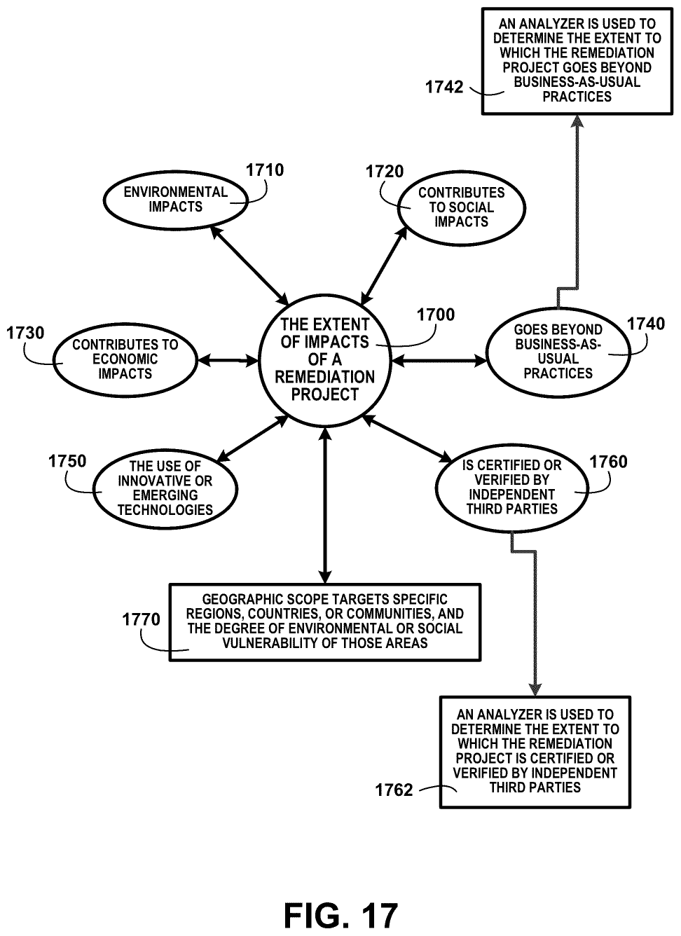

FIG. 17 shows a block diagram of an overview of the environmental impacts of a remediation project of one embodiment. FIG. 17 shows the extent of impacts of a remediation project 1700. The impacts include environmental impacts 1702, the extent the remediation project contributes to social impacts 1704, the extent the remediation project contributes to economic impacts 1706, and the extent the remediation project goes beyond business-as-usual practices 1708. The extent of impacts of a remediation project 1700 additionality includes the use of innovative or emerging technologies 1710 and is certified or verified by independent third parties 1712. Another aspect of the remediation project is the extent the project includes a broad geographic scope that targets specific regions, countries, or communities, and the degree of environmental or social vulnerability of those areas 1714 of one embodiment.

More detailed impacts include the extent the project or initiative contributes to reducing greenhouse gas emissions, protecting biodiversity, promoting sustainable land use, or improving air and water quality, among other environmental factors. Social impacts include the extent to which a remediation project contributes to improving social well-being, promoting gender equality, reducing poverty, promoting access to education and health care, or enhancing community resilience, among other social factors.

Another consideration is economic impacts including a remediation project contributes to creating jobs, promoting economic growth, reducing inequality, promoting sustainable production and consumption patterns, or enhancing energy efficiency and renewable energy, among other economic factors. A determination is made of the geographic scope of the remediation project targets specific regions, countries, or communities, and the degree of environmental or social vulnerability of those areas. Involving technology and innovations including the extent to which the remediation project involves the use of innovative or emerging technologies and the potential for the project to contribute to technology development and diffusion.

The impacts further include a determination of additionality and sustainability including the extent to which the remediation project goes beyond business-as-usual practices and the potential for the project to be sustained over the long term through the use of appropriate financing mechanisms and institutional arrangements. The certification and verification include the extent to which the remediation project is certified or verified by independent third parties, using recognized standards or benchmarks, to ensure the accuracy and integrity of the environmental and social benefits claimed of one embodiment.

An analyzer is used to determine the extent to which the remediation project goes beyond business-as-usual practices 1742 including additionality and sustainability. The remediation project will demonstrate the potential for the project to be sustained over the long term, through the use of appropriate financing mechanisms and institutional arrangements.

An analyzer is used to determine the extent to which the remediation project is certified or verified by independent third parties 1762. The certification will include using recognized standards or benchmarks to ensure the accuracy and integrity of the environmental and social benefits claimed of one embodiment.

### Partial Remediation Device:

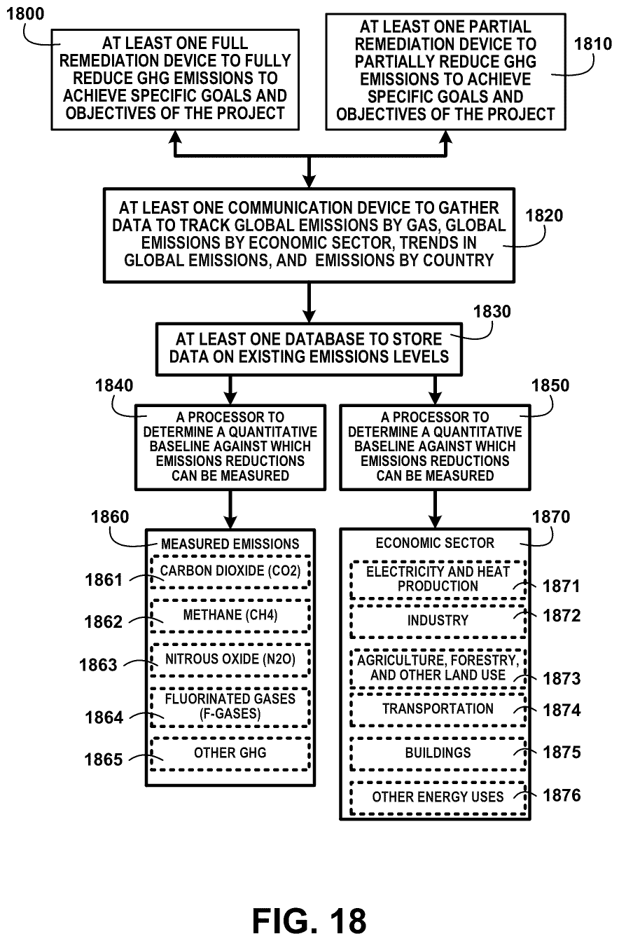

FIG. 18 shows a block diagram of an overview of the partial remediation device of one embodiment. FIG. 18 shows at least one full remediation device to fully reduce GHG emissions to achieve the specific goals and objectives of the project 1800. At least one partial remediation device to partially reduce GHG emissions to achieve specific goals and objectives of the project 1810. At least one communication device to gather data to track global emissions by gas, global emissions by economic sector, trends in global emissions, and emissions by country 1820. FIG. 18 also shows at least one database is used to store data on existing emissions levels 1830. Shown is a processor used to determine a quantitative baseline against which emissions reductions can be measured 1840. The measured emissions 1860 can include carbon dioxide (CO₂) 1861, methane (CH₄) 1862, nitrous oxide (N₂O) 1863, fluorinated gases (f-gases) 1864, and other GHG 1865.

Also showing is a processor used to determine a quantitative baseline against which emissions reductions can be measured 1850 based on an economic sector 1870. The economic sectors include electricity and heat production 1871, industry 1872, agriculture, forestry, and other land use 1873, transportation 1874, buildings 1875, and other energy uses 1876 of one embodiment.

Considerations include reducing greenhouse gas emissions, protecting biodiversity, promoting sustainable land use, or improving air and water quality, among other environmental factors. Remediation project contributions to social impacts will include improving social well-being, promoting gender equality, reducing poverty, promoting access to education and health care, or enhancing community resilience, among other social factors. Remediation project contributions to economic impacts include creating jobs, promoting economic growth, reducing inequality, promoting sustainable production and consumption patterns, or enhancing energy efficiency and renewable energy among other economic factors.

The foregoing has described the principles, embodiments, and modes of operation of the present invention. However, the invention should not be construed as being limited to the particular embodiments discussed. The above-described embodiments should be regarded as illustrative rather than restrictive, and it should be appreciated that variations may be made in those embodiments by workers skilled in the art without departing from the scope of the present invention as defined by the following claims.

What is claimed is:

1. A leak detection and remediation capping system for a wellhead, comprising:
a plurality of sensors in close proximity to the wellhead configured to collect leakage information of a fluid from the wellhead;
a quantification device coupled to the plurality of sensors configured to measure and convert the leakage information into quantifiable data;
a GPS device coupled to the quantification device configured to record a location of the wellhead;
an oil and gas database coupled to the wellhead and configured to store the quantifiable data, carbon credit qualification criteria and carbon credit sources; and
a computer coupled to the oil and gas database and configured to compare the quantifiable data to the carbon credit qualification criteria to determine carbon credit qualifications of the remediation capping system and to identify carbon credit sources appropriate for the remediation capping system.

2. The leak detection and remediation capping system for a wellhead of claim 1, further comprising a cement pumping device to pump cement into the wellhead conductor to plug the flow of the leaking detected fluid.

3. The leak detection and remediation capping system for a wellhead of claim 1, further comprising a database interprocess to compare orphaned oil and gas wellhead database data with carbon credit sources database data to determine carbon credits available for a remediation project to plug the wellhead.

4. The leak detection and remediation capping system for a wellhead of claim 1, wherein the plurality of sensors includes a plurality of gas sensors configured to detect and identify specific leaking gas emissions to qualify for sustainable development goals points.

5. The leak detection and remediation capping system for a wellhead of claim 1, wherein the plurality of sensors includes a plurality of hydrocarbon sensors configured to detect and identify specific leaking fluids including oil.

6. The leak detection and remediation capping system for a wellhead of claim 1, further comprising at least one processor coupled to the orphaned oil and gas wellhead database configured to rank GHG gases and chemical emissions based on negative effects on an environment.

7. The leak detection and remediation capping system for a wellhead of claim 1, further comprising a plurality of equipment and devices configured to remove physical wellhead equipment after plugging and confirmation leaking has been stopped.

8. The leak detection and remediation capping system for a wellhead of claim 1, further comprising a plurality of equipment and devices configured to reclaim a plugged wellhead site in accordance with applicable regulations and standards.

9. A leak detection and remediation capping system for a wellhead, comprising:
a plurality of sensors in close proximity to the wellhead configured to collect leakage information of a fluid from the wellhead;
a quantification device coupled to the plurality of sensors configured to measure and convert the leakage information into quantifiable data;
wherein the quantification device determines a flow rate of the fluid leakage;
a GPS device coupled to the quantification device configured to record a location of the wellhead;
an oil and gas database coupled to the wellhead and configured to store the quantifiable data, carbon credit qualification criteria and carbon credit sources; and
a computer coupled to the oil and gas database and configured to compare the quantifiable data to the carbon credit qualification criteria to determine carbon credit qualifications of the remediation capping system and to identify carbon credit sources appropriate for the remediation capping system.

10. The leak detection and remediation capping system for a wellhead of claim 9, wherein the computer is further configured to determine a one tonne of CO₂ equivalent for each gas detected and identified.

11. The leak detection and remediation capping system for a wellhead of claim 9, wherein the detected leakage of a fluid from the wellhead includes gas emissions including carbon dioxide (CO₂), methane (CH₄), nitrous oxide (N₂O), fluorinated gases (f-gases), and other greenhouse gases qualifying for sustainable development goals points.

12. The leak detection and remediation capping system for a wellhead of claim 9, further comprising at least one processor coupled to the orphaned oil and gas wellhead database configured to rank greenhouse gases and chemical emissions based on negative effects on an environment.

13. The leak detection and remediation capping system for a wellhead of claim 9, further comprising a cement pumping device to pump cement into the wellhead conductor to plug the flow of the leaking detected fluid.

14. The leak detection and remediation capping system for a wellhead of claim 9, further comprising a plurality of equipment and devices configured to remove physical wellhead equipment after plugging and confirmation leaking has been stopped.

15. A leak detection and remediation capping system for a wellhead, comprising:
a plurality of sensors in close proximity to the wellhead configured to collect leakage information of a fluid from the wellhead;
wherein the plurality of sensors includes gas sensors configured to detect and identify greenhouse gases;
wherein the plurality of sensors includes a hydrocarbon sensors configured to detect and identify leaking fluids including oil;
a quantification device coupled to the plurality of sensors configured to measure and convert the leakage information into quantifiable data;
a GPS device coupled to the quantification device configured to record a location of the wellhead;
an oil and gas database coupled to the wellhead and configured to store the quantifiable data, carbon credit qualification criteria and carbon credit sources; and
a computer coupled to the oil and gas database and configured to compare the quantifiable data to the carbon credit qualification criteria to determine carbon credit qualifications of the remediation capping system and to identify carbon credit sources appropriate for the remediation capping system.

16. The leak detection and remediation capping system for a wellhead of claim 15, wherein the quantification device determines a flow rate of the fluid leakage.

17. The leak detection and remediation capping system for a wellhead of claim 15, wherein the detected leakage of a fluid from the wellhead includes gas emissions including carbon dioxide (CO₂), methane (CH₄), nitrous oxide (N₂O), fluorinated gases (f-gases), and other greenhouse gases.

18. The leak detection and remediation capping system for a wellhead of claim 15, wherein the computer is further configured to determine a one tonne of CO₂ equivalent for each gas detected and identified.

19. The leak detection and remediation capping system for a wellhead of claim 15, further comprising a plurality of equipment and devices configured to remove physical wellhead equipment after plugging and confirmation leaking has been stopped.

20. The leak detection and remediation capping system for a wellhead of claim 15, further comprising a plurality of equipment and devices configured to reclaim a plugged wellhead site in accordance with applicable regulations and standards.
